(19) United States
(12) Patent Application Publication
(10) Pub. No.: US 2006/0110669 A1
(43) Pub. Date: May 25, 2006

(54) Electrophotographic image member

(76) Inventors: David J. Maty, Ontario, NY (US); John A. Bergfjord SR., Macedon, NY (US); Tsu-sen Chow, Sacramento, CA (US); Kathleen Carmichael, Williamson, NY (US)

Correspondence Address: PILLSBURY WINTHROP SHAW PITTMAN, LLP, P.O. BOX 10500, MCLEAN, VA, 22102, US

(21) Appl. No.: 10/996,089

(22) Filed: Nov. 23, 2004

(51) Int. Cl. G03G 5/047; G03G 5/06

(52) U.S. Cl. 430/59.6; 430/133; 430/58.8

(57) ABSTRACT

An electrophotographic imaging member is disclosed which is provided with a charge transport layer comprising at least one polycarbonate polymer binder having a weight average molecular weight based on polystyrene units of from about 150,000 to about 190,000 and at least one polycarbonate binder having a weight average molecular weight based on polystyrene units of from about 230,000 to about 300,000 and a hole transport material.

### BACKGROUND

Disclosed is an imaging member, a method and system for suppressing electrostatographic, and more particularly electrophotographic, imaging member cracking. In a specific embodiment, there is disclosed a process for improving photoreceptor charge transport layer fatigue crack resistance under stress such as mechanical cycling.

Electrostatographic imaging members are widely used to form images. In particular they are used in “printers” which will be understood to include copiers, printers, and multifunction printing systems, wherein the image captured on the imaging member is transferred to a material, such as print media sheets, plastic, wood, etc.

An electrostatographic imaging member comprises a conductive layer and an insulating layer on which an image may be formed by selective charge manipulation. When the charge manipulation is by means of electromagnetic radiation such as light such member may be referenced to as an electrophotographic imaging member. The conductive layer may reflect several designs such as a homogeneous layer of a single material such as vitreous selenium, selenium-tellurium alloy, selenium-arsenic alloy, cadmium sulfide, etc., or a composite layer containing a photoconductor and other materials. Electrophotographic imaging members may take several forms including flexible seamed or seamless belts, rigid drums, flexible scrolls, etc., and may be employed in “print devices” such as copiers, printers and multifunction devices with xerographic, ink jet or other print media printing systems.

An electrophotographic imaging member may comprise a number of layers, such as in a multilayered or “laminated” photoreceptor. Electrophotographic imaging members are often multilayered, with the multiple layers offering in some cases for easier control of the electrical properties, such as charge potential, exposure potential, and retention of charge with respect to a defined electric field of the electrophotographic imaging member as compared to a single-layered photoreceptor in which a single layer must have various electrical properties. Multilayered electrophotographic imaging members as illustrated in FIG. 1, often comprise a supporting substrate layer (6) (which may be formed from a conductive material), a charge generating layer (2) (which may have for example a light-absorbing material), a charge transport layer (1), which may comprise electron donor molecules, a charge blocking layer (4), an adhesive layer (3) for adhering the charge blocking layer (4) and charge generating layer (2), and an optional electrically conductive ground plane (5). The charge transport layer and charge generating layer may, for example, be coated on the electrically conductive support, and either the charge generating layer or the charge transport layer may be located adjacent the conductive layer. A protective undercoat layer and overcoat layer (20) may be also found. It may further contain other optional adhesive layer(s) and optional anti-curl backing layer(s).

A charge generating layer is capable of photogenerating charge and injecting the photogenerated charge into the charge transport layer. Charge-generating layers may comprise a resin dispersed pigment including photoconductive compounds such as, but not limited to, zinc oxide or cadmium sulfide, and organic pigments such as, but not limited to, phthalocyanine type pigment, a polycyclic quinone type pigment, a perylene pigment, an azo type pigment and a quinacridone type pigment. Positive charges (holes) are injected into a charge transport layer while negative charges (electrons) migrate to a surface layer to neutralize surface charges, reducing a surface potential at an exposed portion, thereby forming a latent image. The charge transport layer may, for example, comprise electron donor molecules in a polymer binder with the electron donor molecules providing hole or charge transport properties, and the polymer binder providing mechanical properties with electrical inactivity. The charge transport layer may also comprise a charge transporting polymer such as poly(N-vinylcarbazole), polysilylene or polyether carbonate, wherein the charge transport properties are incorporated into the mechanically strong polymer.

A multilayered electrophotographic imaging member, such as a multilayered photoreceptor may be used, for example, inside of a marking system on which a latent image is written by a laser or light emitting diode (LED) bar and then developed with a toner. For example, the multilayered electrophotographic imaging member may be exposed to a pattern of activating electromagnetic radiation such as light in a manner to selectively dissipate the charge in the illuminated areas of the photoconductive insulating layer while leaving behind an electrostatic latent image in the non-illuminated areas. The electrostatic latent image may then be developed to form a visible image by depositing, for example, finely divided electroscopic toner particles on the surface of the photoconductive insulating layer, and the image transferred to a suitable receiving member such as paper.

In a xerographic system, the electrophotographic imaging member may be negatively charged with static electricity by a high-voltage wire, such as a charge corona. The reflected light image (copier) or laser light (printer) may be used to create a latent image on the electrophotographic imaging member surface by selectively dissipating charge at the exposed surface, leaving the unexposed surface retaining negative static electricity charge. The negative charged latent image of the electrophotographic imaging member may be exposed to positively charged toner to form a visible image on the electrophotographic imaging member. A substrate may be positioned in register between the electrophotographic imaging member and a charge source, such as a high-voltage corona, which provides charge to the substrate. As for example, a positive charge on the paper attracts negatively charged toner from the electrophotographic imaging member surface an image will form on the paper. When the charge on the substrate, such as paper, is removed, the substrate may separate from the electrophotographic imaging member. Heat and pressure, and optionally materials such as fusing oil, may be used to bond the toner to the substrate. A cleaning blade may be used to clean the photoreceptor of any remaining toner.

Flexible multilayer electrophotographic imaging member(s), such as photoreceptors, may under long, repeated use and high stress conditions, such as, high temperature, high relative humidity, and rapid cycling, degrade or lose integrity of the photoreceptor layers. In belt-like flexible photoreceptors cracks in the photoreceptive layer may appear in a copy image as a crack pattern or print-out defects. Cracks in belt-like photoreceptors may be due to dynamic fatigue of the belt flexing over the supporting rollers of a machine belt support module, or other factors, such as exposure to airborne chemical contaminants such as solvent vapors and corona species emitted by machine charging subsystems while the photoreceptor belt is subjected to bending stress. Cracking is of particular problem when a photoreceptor belt are cycled over small diameter rollers, e.g., less than about 0.75 inch (19 mm) diameter.

The early onset of charge transport layer cracking is a belt material failure issue that may impact copy print-out quality, thereby cutting short the functional performance of the imaging member belt prior to reaching its intended service life. Photoreceptor replacement in electrostatographic devices such as copiers and printers may be quite expensive.

The cracking degradation of the layers of a multilayer electrophotographic imaging member, such as a photoreceptor, may be observed as black spots in prints which develop as a result of charge deficient spots (CDS) and cyclic instability. Print defects associated with charge deficient spots, or black spots, are therefore, a major shortcoming in xerographic systems and usually attributed to electrical leakage across the multilayers at those spots. Although sources of such electrical leakage are multifold, degradation or delamination of interfaces is often involved, in particular among the three active layers of a layered photoreceptor, i.e., the undercoat layer (“UCL”), the charge-generating layer (“CGL”), and the charge-transport layer (“CTL”), and between the undercoat layer (“UCL”) and substrate. The degradation induces a conductive path transversal of the photoreceptor and causing the electrical leakage. Charge deficient spot electrical failure mechanisms show high point source discharges of electric fields under high stress conditions, such as high temperature, high relative humidity and rapid cycling. The failure may be observed as black spots in prints.

In relation to organic layered-type electrophotographic imaging member the mechanical properties of the CTL in particular may determine the physical strength of the surface of the photoreceptor. In flexible layered-type electrophotographic imaging member, it is frequently the case that the charge transporting layer bears much of the load. The strength of a charge transport layer which comprises charge transporting material and binder resin frequently relates to binder. As the amount of the doped charge transporting material is often considerably large, the layer is often not provided with desired mechanical strength. Various charge transport components are known including hole transporting compounds and molecules, in particular arylamine charge hole transporter molecules represented by the following molecular structure wherein X,X′ is selected from the group consisting of alkyl, hydroxy, and halogen.

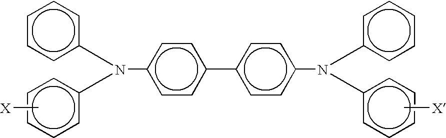

Charge transport layers may comprise binders comprising polymers or copolymers of vinyl compounds such as styrene, vinyl acetate, vinyl chloride, acryl esters, methacryl esters, butadiene etc. and thermoplastic and/or thermosetting resins such as polyvinylacetal, polycarbonate, polyester, polysulfone, poly(phenylene oxide), polyurethane, cellulose esters, cellulose ethers, phenoxy resins, silicon resins, epoxy resins, etc., including those binders set forth in U.S. Patent Publication No. 2004/0115547 A1, incorporated by reference in its entirety herein.

To increase the mechanical strength of the surface of a electrophotographic imaging member, JP-A-61-72256 discloses, for example, an overcoat layer to protect the charge transport layer. While protective overcoats have been used to reduce wear rates and increase life, overcoats may cause an accumulation of residual charge during cycling, resulting in a condition known as cycle-up in which the residual potential continues to increase with multi-cycle operation which in turn may give rise to increased densities in the background areas of final images. JP-A-63-148263 and JP-A-3-221962 disclose alternatives for increasing mechanical strength of the photoreceptor which include use of a binder polymer having high abrasion resistance. JP-A-61-132954 and JP-A-2-240655 disclose methods for improving surface smoothness through use of, for example, polysiloxane block copolymer as a binder. JP-A-7-261440 discloses using a polysiloxane terminal compound of low molecular weight for improving the quality of the overcoat. JP-A-5-306335, JP-A-6-32884, and JP-A-6-282094 disclose employing a fluorine atom-containing polycarbonate in the overcoat, and U.S. Pat. No. 6,165,662 discloses the employment of a polycarbonate resin having a polysiloxane at its terminals and a viscosity-average molecular weight of from 10,000 to 300,000 to increase the mechanical strength of the photoreceptor.

### REFERENCES

Examples of electrophotographic imaging members having at least two electrically operative layers including a charge generating layer and a charge transport layer are disclosed in U.S. Pat. Nos. 4,365,990, 4,233,394, 4,306,008, 4,299,897 and 4,439,507.

U.S. Pat. No. 5,292,607 discloses a photoreceptor having a photosensitive layer containing a specific carbonate resin binder resin having a weight average molecular weight of not less than 200,000. The resin is preferably a polycarbonate resin. The photosensitive layer containing such polycarbonate may be formed by spray coating or spiral coating.

U.S. Pat. No. 6,136,946 discloses a binder resin having improved mechanical properties and flexibility comprising polycarbonate having a weight average molecular weight calculated as polystyrene of 50,000 or more. A method for obtaining such high-molecular-weight polycarbonate which does not entail phosgene is disclosed.

U.S. Pat. No. 6,165,662 discloses an electrophotographic photoreceptor having a photosensitive layer containing a binder resin on an electroconductive substrate, wherein at least a part of the binder resin in the photosensitive layer is a polycarbonate resin having a defined structure and having a viscosity-average molecular weight of from 10,000 to 300,000.

U.S. Pat. No. 6,337,166 discloses a charge transport layer composition of a photoreceptor containing polytetrafluoroethylene (PTFE) particles which is disclosed to impart superior wear resistance to a photoreceptor and toner transfer efficacy.

U.S. Patent Application Publication No. 2004/0115547 A1 discloses a polycarbonate resin with a weight average molecular weight of from about 20,000 to about 100,000 as a useful binder in photoconductive layers, with excellent imaging results being said to be achieved with poly(4,4′-diphenyl-1,1′-cyclohexane carbonate-500, with a weight average molecular weight of 51,000, or poly(4,4′-diphenyl-1,1′-cyclohexane carbonate-4000, with a weight average molecular weight of 40,000.

U.S. Patent Application Publication No. 2004/0126685 discloses an imaging member having a charge transport layer with multiple regions. Coated from solutions of similar or different compositions or concentrations wherein at least the top or uppermost transport layer comprises a lower concentration of charge transport compound than the first (bottom) charge transport layer. The charge transport layer is disclosed to provide enhanced cracking suppression, improved wear resistance, and imaging member electrical performance.

The disclosures of each of these patents is herein incorporated by reference in their entirety.

### SUMMARY

Aspects disclosed herein include

a charge transport layer material for a photoreceptor comprising at least one polycarbonate polymer binder having a weight average molecular weight based on polystyrene units of from about 150,000 to about 190,000 and at least one polycarbonate binder having a weight average molecular weight based on polystyrene units of from about 230,000 to about 300,000; and

an electrophotographic imaging member comprising an electroconductive support and a photosensitive layer containing a photoconductive material and a binder resin, and a charge transporting layer comprising a polycarbonate resin having a weight average molecular weight based on polystyrene units of from about 150,000 to about 190,000 and a polycarbonate resin having a weight average molecular weight based on polystyrene units of from about 230,000 to about 300,000; and

a process comprising dissolving a first polycarbonate with an about 230,000 to about 300,000 weight average molecular weight polycarbonate based on polystyrene units in a solution; adding a second polycarbonate with an about 150,000 to about 190,000 weight average molecular weight polycarbonate based on polystyrene units into said solution; adding hole transport components to said first and second polycarbonate; and

an electrophotographic imaging member comprising a support substrate, at least one imaging layer on one side of said support substrate, a charge blocking layer, an optional adhesive layer, and a charge transporting layer, wherein said charge transporting layer comprises binder resin comprising a polycarbonate resin having a weight average molecular weight based on polystyrene units of from about 150,000 to about 190,000 and a polycarbonate resin having a weight average molecular weight based on polystyrene units of from about 230,000 to about 300,000.

### BRIEF DESCRIPTION OF THE DRAWINGS

FIG. 1 generally illustrates an exemplary embodiment of an electrophotographic imaging member.

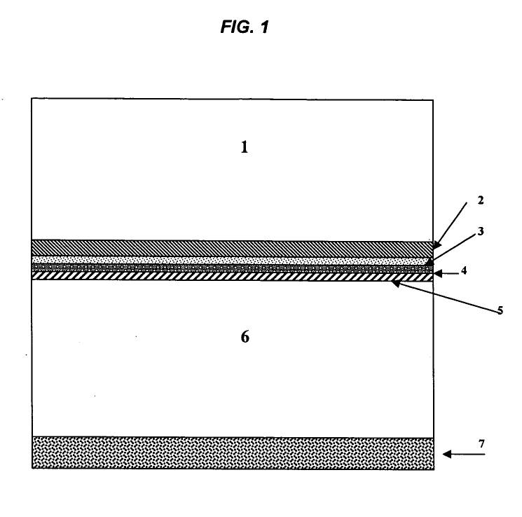

### DETAILED DESCRIPTION

In embodiments there is illustrated:

an electrophotographic imaging member comprising an electroconductive support and a photosensitive layer containing a photoconductive material and a charge transport layer comprising a polycarbonate resin having a weight average molecular weight based on polystyrene units of from about 150,000 to about 190,000 and a polycarbonate resin having a weight average molecular weight based on polystyrene units of from about 230,000 to about 300,000;

An electrophotographic photoreceptor may comprise a functional separation between charge generating materials and materials that transfer the charge. A functional separation-type photoreceptor may be formed, for example, by laminating a charge generation layer that generates a charge through exposure and a charge transfer layer that transfers a charge.

The electrophotographic imaging member substrate may comprise any suitable organic or inorganic material having the requisite mechanical and electrical properties. It may be formulated entirely of an electrically conductive material, or it can be an insulating material including inorganic or organic polymeric materials, such as polyester, polyester coated titanium, a layer of an organic or inorganic material having a semiconductive surface layer, such as indium tin oxide, aluminum, aluminum alloys, titanium, titanium alloys, or any electrically conductive or insulating substance other than aluminum, or may be made up of exclusively conductive materials such as aluminum, chromium nickel, brass, copper, nickel, zinc, chromium, stainless steel, aluminum, semitransparent aluminium, steel, cadmium, silver, gold, zirconium, niobium, tantalum, vanadium, hafnium, titanium, tungsten, indium, tin, metal oxides, conductive plastics and rubbers, and the like. It may be opaque or substantially transparent. The substrate may be flexible, seamless or rigid and may have a number of many different configurations, such as, for example, a plate a drum, a scroll, an endless flexible belt and the like. The thickness of the substrate layer depends on numerous factors, including mechanical performance and economic consideration, and may in embodiments range from about 50 micrometers to about 3,000 micrometers, and in embodiments, from about 75 micrometers to about 1,000 micrometers when flexibility and minimum induced surface bending stress may be a problem. The entire substrate can comprise the same material as that in the electrically conductive surface or the electrically conductive surface can be merely a coating on the substrate.

Numerous charge generating materials for transporting holes into the charge transport layer are known including inorganic pigments such as zinc oxide and cadmuim sulfide, and organic pigments such as phthalocyanine type pigment (metal containing—such as copper, indium, gallium, tin, titanium, zinc, vanadium, silicon or germanium, or it's oxide or halide—and non-metal containing—such as X-type or τ-type phthalocyanine, chloroindium phthalocyanine, chlorogallium phthalocyanine, hydroxygallium phthalocyanine, hydroxysilicon phthalocyanine, oxytitanium phthalocyanine), a polycyclic quinone type pigment, a perylene pigment (such as benzimidazole perylene), an azo type pigment and a quinacridone type pigment. Charge generating materials may be bound by various binder resins such as polyester resin, polyvinyl acetate, polyacrylate, a polymethacrylate, a polyester, a polycarbonate, a polyvinyl acetoacetal, a polyvinyl propional, a polyvinyl butyral, a phenoxy resin, an epoxy resin, an urethane resin, a cellulose ester and a cellulose ether.

When the photogenerating material is present in a binder material, the photogenerating composition or pigment may be present in the film forming polymer binder compositions in any suitable or desired amounts. For example, from about 10 percent by volume to about 60 percent by volume of the photogenetating pigment may be dispersed in about 40 percent by volume to about 90 percent by volume of the film forming polymer binder composition, alternatively from about 20 percent by volume to about 30 percent by volume of the photogenerating pigment may be dispersed in about 70 percent by volume to about 80 percent by volume of the film forming polymer binder composition. The photoconductive material may be present in the photogenerating layer in an amount of from about 5 to about 80 percent by weight, alternatively from about 25 to about 75 percent by weight. The binder may be present in an amount of from about 20 to about 95 percent by weight, alternatively from about 25 to about 75 percent by weight, although the relative amounts can be outside these ranges.

The particle size of the photoconductive compositions and/or pigments may be less than the thickness of the deposited solidified layer or, for example, between about 0.01 micron and about 0.5 micron to facilitate better coating uniformity.

The photogenerating layer containing photoconductive compositions and the resinous binder material may range in thickness, for example, from about 0.05 micron to about 10 microns or more, alternatively from about 0.1 micron to about 5 microns, or alternatively from about 0.3 micron to about 3 microns, although the thickness can be outside these ranges. The photogenerating layer thickness is related to the relative amounts of photogenerating compound and binder, with the photogenerating material, for example, being present in amounts of from about 5 to about 100 percent by weight. Higher binder content compositions generally require thicker layers for photogeneration. It may be desirable to provide this layer in a thickness sufficient to absorb about 90 percent or more of the incident radiation which is directed upon it in the imagewise or printing exposure step. The maximum thickness of this layer is dependent upon factors such as mechanical considerations, the specific photogenerating compound selected, the thicknesses of the other layers, and whether a flexible photoconductive imaging member is desired.

The photogenerating layer can be applied to underlying layers by any desired or suitable method. Any suitable technique may be utilized to mix and thereafter apply the photogenerating layer coating mixture. Application techniques include spraying, dip coating, roll coating, wire wound rod coating, and the like. Drying of the deposited coating may be effected by any suitable technique, such as oven drying, infra red radiation drying, air drying and the like.

Any suitable solvent may be utilized to dissolve the film forming binder. Typical solvents include, for example, tetrahydrofuran, toluene, methylene chloride, monochlorobenzene and the like. Coating dispersions for charge generating layer may be formed by any suitable technique using, for example, attritors, ball mills, Dynomills, paint shakers, homogenizers, microfluidizers, and the like.

The charge transport layer may comprise one or more layers or regions, such as a bottom charge transport layer and an upper or additional charge transport layer(s) such as disclosed in U.S. Patent Publication No. 2004/0126685 A1 which is herein incorporated by reference in its entirety. The charge transport layer may have a thickness of between, for example, from about 10 micrometers to about 50 micrometers. The thickness of the charge transport layer to the charge generating layer may be maintained from about 2:1 to about 200:1; and in some instances as great as about 400:1.

The electrophotographic imaging member may also comprise optional charge blocking layers, such as disclosed in U.S. Patent Publication No. 2004/0115547 A1(herein incorporated by reference in its entirety), adhesive layers (in particular between the charge generating and the conductive layer—see, for example, without limitation, U.S. Pat. No. 6,790,573 B2 herein incorporated by reference in its entirety), and overcoat, such as for example disclosed in U.S. Patent Publication US 2004/0143056 A1 and 2004/0115543 A1 (herein incorporated by reference in their entirety) and undercoat layers.

The optional overcoat layer can be comprised of, for example, silicon, silicon containing other components such as copolyester-polycarbonate resin or polycarbonate, or polycarbonate mixtures. An optional undercoat layer can be made for example of a binder resin which may include a donor molecule.

The optional adhesive layer can comprise, for example, polyesters, polyarylates, polyurethanes, copolyester-polycarbonate resin, and the like. The adhesive layer may be of a thickness, for example, from about 0.01 micrometers to about 2 micrometers after drying, and in other embodiments from about 0.03 micrometers to about 1 micrometer. The optional hole blocking layer can be comprised of, for example, polymers such as polyvinylbutyral, epoxy resins, polyesters, polysiloxanes, polyamides, polyurethanes, and the like, or may be nitrogen containing siloxanes or nitrogen containing titanium compounds such as trimethoxysilyl propylene diamine, hydrolyzed trimethoxysilyl propyl ethylene diamine, N-beta-(aminoethyl)gamma-amino-propyl trimethoxy silane, isopropyl 4-aminobenzene sulfonyl, di(dodecylbenzene sulfonyl)titanate, isopropyl di(4-aminobenzoyl)isostearoyl titanate, isopropyl tri(N-ethylaminoethylamino)titanate, isopropyl trianthranil titanate, isopropyl tri(N,N-dimethyl-ethylamino)titanate, titanium-4-amino benzene sulfonate oxyacetate, titanium 4-aminobenzoate isostearate oxyacetate, [H₂N(CH₂)₄]CH₃Si(OCH₃)₂, gamma-aminobutyl)methyl diethoxysilane, [H₂N(CH₂)₃]CH₃Si(OCH₃)₂, (gamma-aminopropyl)-methyl diethoxysilane, vinyl hydroxyl ester and vinyl hydroxy amide polymers wherein the hydroxyl groups have been partially modified to benzoate and acetate esters that modified polymers are then blended with other unmodified vinyl hydroxy ester and amide unmodified polymers, alkyl acrylamidoglycolate alkyl ether containing polymer, the copolymer poly(methyl acrylamidoglycolate methyl ether-co-2-hydroxyethyl methacrylate), zinc oxide, titanium oxide, silica, polyvinyl butyral, and phenolic resins. The blocking layer in embodiments may be continuous and may have a thickness of less than from about 10 micrometers, and more specifically, from about 1 to about 5 micrometers.

The active charge transport layer may comprise any suitable activating compound useful as an additive dispersed in electrically inactive polymeric materials making these materials electrically active. These compounds may be added to polymeric materials which are incapable of supporting the injection of photogenerated holes from the generation material and incapable of allowing the transport of these holes therethrough. This will convert the electrically inactive polymeric material to a material capable of supporting the direction of photogenerated holes from the generation material and capable of allowing the transport of these holes through the active layer in order to discharge the surface charge on the active layer. A transport layer employed in one of the two electrically operative layers in a multilayered photoconductor may comprise, for example, from about 25 percent to about 75 percent by weight of at least one charge transporting aromatic amine compound, and about 75 percent to about 25 percent by weight of a polymeric film forming binder resin in which the aromatic amine is soluble.

The charge transport layer forming mixture may comprise an aromatic amine compound of one or more compounds having the general formula: 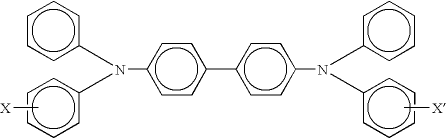
wherein X, X′ is selected from the group consisting of alkyl, hydroxy, and halogen. Examples of charge transporting aromatic amines represented by the structural formulae above for charge transport layers capable of supporting the injection of photogenerated holes of a charge generating layer and transporting the holes through the large transport layer include, for example, triphenylmethane, bis(4-diethylamine-2—methylphenyl)phenylmethane, 4′-4″-bis(diethylamino)-2′,2″-dimethyltriphenylmethane, N,N′-bis(alkylphenyl)-(1,1′-biphenyl)-4,4′-diamine wherein the alkyl is, for example, methyl, ethyl, propyl, n-butyl, etc., N,N′-diphenyl-N,N′-bis(chlorophenyl)-(1,1′-biphenyl)4,4′-diamine, N,N′-diphenyl-N,N′-bis(3″-methylphenyl)-(1,1′-biphenyl)-4,4′-diamine, and the like dispersed in an inactive resin binder.

Any suitable inactive resin binder soluble in methylene chloride or other suitable solvent such as, for example, tetrahydrofuran, toluene, monochlorobenzene and the like may be employed. Typical inactive resin binders soluble in methylene chloride include polycarbonate resin, polyvinylcarbazole, polyester, polyarylate, polyacrylate, polyether, polysulfone, and the like. Weight average molecular weights may vary, for example, from about 20,000 to about 150,000. To the charge transport layer, known additives such as a plasticizer, an antioxidant, an ultraviolet absorber, an electron attractive compound and a leveling agent, may be incorporated in order to improve the film-forming property, flexibility, coating property, antifouling property, gas resistance or light resistance.

In an embodiment, the polymer binder in the charge transport layer may comprise a polycarbonate, particularly a polycarbonate of the structure 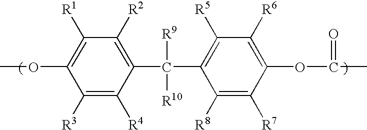
wherein R¹, R², R³, R⁴, R⁵, R⁶, R⁷ and R⁸ are respectively and independently a hydrogen atom, a lower alkyl group, such as methyl, ethyl, iso-propyl, etc., a halogen atom, such as a chlorine atom, bromine atom, etc., or an unsubstituted or substituted aromatic group, such as phenyl, naphthyl, tolyl, etc.; and R⁹ and R¹⁰ are respectively and independently a hydrogen atom, a lower alkyl group, such as methyl, ethyl, iso-propyl, etc., or an unsubstitued or substituted aromatic group, such as phenyl, naphthyl, tolyl, etc., or form a ring or a carbonyl group together with the linking carbon atom. Useful polycarbonates may include polycarbonate Z polymers (bisphenol Z type polycarbonate polymers) and polycarbonate A polymers (bis-phenol A wherein the cyclohexyl of bisphenol Z is replaced with a methyl substituent) or a combination thereof.

As the molecular weight of the polycarbonate increases, the processing becomes more difficult while the melt flow rate decreases. In respect of polycarbonate resin having a weight average molecular weight based on polystyrene units of from about 230,000 to about 300,000, such resins are normally difficult to dissolve. Such material may not be placed into solution itself without the use of heat or excessive processing. It has been found that by placing the polycarbonate resin having a weight average molecular weight based on polystyrene units of from about 230,000 to about 300,000 first into solution, followed by the polycarbonate resin having a weight average molecular weight based on polystyrene units of from about 150,000 to about 190,000, that the hole transport molecule/compounds, such as, but not limited to, m-TBD, can be readily added to the solution to form a solution that may be used as a coating to form the charge transfer layer. By solving sequentially the polycarbonates, gel problems may be overcome. Solving may be performed in any solvent that dissolves each of the polycarbonates, and may include methylene chloride, tetrahydrofuran, or a brominated organic solvent. The charge transfer layer formed by the material may demonstrate improved cyclic life.

### EXAMPLE 1

### Preparation of an Electrophotographic Imaging Member

An electrophotographic imaging member was prepared by providing a 0.02 micrometer thick titanium layer coated on a substrate of a biaxially oriented polyethylene naphthalate substrate (KADALEX™, available from Dupont Teijin Films.) having a thickness of 3.5 mils (89 micrometers). The titanized Kadalex™ substrate was extrusion coated with a blocking layer solution containing a mixture of 6.5 grams of gamma aminopropyltriethoxy silane, 39.4 grams of distilled water, 2.08 grams of acetic acid, 752.2 grams of 200 proof denatured alcohol and 200 grams of heptane. This wet coating layer was then allowed to dry for 5 minutes at 135° C. in a forced air oven to remove the solvents from the coating and effect the formation of a crosslinked silane blocking layer. The resulting blocking layer was of an average dry thickness of 0.04 micrometer as measured with an ellipsometer.

An adhesive interface layer was then applied by extrusion coating to the blocking layer with a coating solution containing 0.16 percent by weight of ARDEL® polyarylate, having a weight average molecular weight of about 54,000, available from Toyota Hsushu, Inc., based on the total weight of the solution in an 8:1:1 weight ratio of tetrahydrofuran/monochloro-benzene/methylene chloride solvent mixture. The adhesive interface layer was allowed to dry for 1 minute at 125° C. in a forced air oven. The resulting adhesive interface layer had a dry thickness of about 0.02 micrometer.

The adhesive interface layer was thereafter coated over with a charge generating layer. The charge generating layer dispersion was prepared by adding 0.45 gram of IUPILON 200®, a polycarbonate of poly(4,4′-diphenyl)-1,1′-cyclohexane carbonate (PC-z 200) available from Mitsubishi Gas Chemical Corporation, and 50 milliliters of tetrahydrofuran into a 4 ounce glass bottle. 2.4 grams of hydroxygallium phthalocyanine Type V and 300 grams of ⅛ inch (3.2 millimeters) diameter stainless steel shot were added to the solution. This mixture was then placed on a ball mill for 8 hours. Subsequently, 2.25 grams of poly(4,4′-diphenyl-1,1′-cyclohexane carbonate) having a weight average molecular weight of 20,000 (PC-z 200) were dissolved in 46.1 grams of tetrahydrofuran, then added to the hydroxygallium phthalocyanine slurry. This slurry was then placed on a shaker for 10 minutes. The resulting slurry was thereafter coated onto the adhesive interface by extrusion application process to form a layer having a wet thickness of 0.25 ml. However, a strip of about 10 millimeters wide along one edge of the substrate web stock bearing the blocking layer and the adhesive layer was deliberately left uncoated by the charge generating layer to facilitate adequate electrical contact by a ground strip layer to be applied later. This charge generating layer comprised of poly(4,4′-diphenyl)-1,1′-cyclohexane carbonate, tetrahydrofuran and hydroxygallium phthalocyanine was dried at 125° C. for 2 minutes in a forced air oven to form a dry charge generating layer having a thickness of 0.4 micrometer.

This coated generating layer was simultaneously coated over with a charge transport layer. The charge transport layer was prepared by introducing into an amber glass bottle in a weight ratio of 1:1 (or 50 weight percent of each) of MAKROLON 5705®, a Bisphenol A polycarbonate thermoplastic having a molecular weight of about 170,000, and a glass transition temperature (Tg) of 156° C. commercially available from Farbensabricken Bayer A.G., and N,N′-diphenyl-N,N′-bis(3-methylphenyl)-1,1′-biphenyl-4,4′-diamine (m-TBD) charge transporting compound represented by 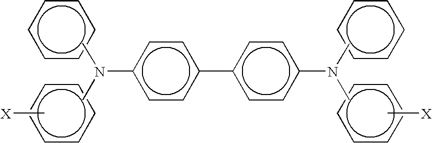
wherein X is a methyl group that attached to the meta position.

The resulting mixture was dissolved to give 15 percent by weight solid in methylene chloride. This solution was applied on the charge generating layer to form a coating which upon drying in a forced air oven through 125° C. for 3 minutes gave a 29 micrometers dry thickness charge transport layer.

### EXAMPLE 2

### Preparation of a Second Electgrophotographic Imaging Member

An electrophotographic imaging member was fabricated using the same materials and the same process as those described in Example 1, but with the exception that the charge transport layer was prepared as follows: the CTL was prepared by admixing fifty weight percent Bayer (Makrolon) 5900 (approximately 250,000 weight average molecular weight based on polystyrene units) into in excess methylene chloride to dissolve the same. Fifty weight percent of Bayer 5705 (Makrolon) (approximately 170,000 weight average molecular weight based on polystyrene units) was then added to the solution. Transport material (m-TBD) is solved into the polycarbonate blend to form the CTL solution.

### EXAMPLE 3

### Dynamic Fatigue Testing OF Electrophotographic Imaging Members of Examples 1 and 2

Cycling tests using cycling rigs are performed to determine improved mechanical cycling life of photoreceptors with 5900/5705 Makrolon polycarbonate blends as compared to 5705 polycarbonate only. For dynamic fatigue testing, each of these electrophotographic imaging members was cut to give a test sample size of 1 inch (2.54 cm.) by 12 inches (30.48 cm.) and each dynamically tested to the point that occurrence of fatigue charge transport layer cracking became evidence. Testing was effected by means of a dynamic mechanical cycling device in which free rotating (idle) rollers were employed to repeatedly bend and flex each imaging member test sample to induce fatigue strain in the charge transport layer as to simulate an imaging member belt cyclic function under a machine service condition. More specifically, one end of the test sample was clamped to a stationary post and the sample was then looped upwardly over three equally spaced horizontal idling rollers and then downwardly through a generally inverted “U” shaped path with the free end of the sample secured to a weight which provided one pound per inch width tension on the sample. The outer surface of the imaging member were faced outwardly, so that the outer most layer of the imaging member samples would periodically be brought into dynamic bending/flexing contact as the idling rollers were repeatedly passing underneath the test sample to cause mechanical fatigue charge transport layer strain. The idling rollers had a diameter of one inch.

Each idling roller was secured at each end to an adjacent vertical surface of a pair of disks that were rotatable about a shaft connecting the centers of the disks. The rollers were parallel to and equidistant from each other and equidistant from the shaft connecting the centers of the disks. Although the disks were rotated about the shaft, each roller was secured to the disk but rotating freely around each individual roller axis. Thus, as the disk rotated about the shaft, two rollers were maintained at all times in rotating contact with the back surface of the test sample. The axis of each roller was positioned about 4 cm from the shaft. The direction of movement of the rollers along the charge transport layer surface was away from the weighted end of the sample toward the end clamped to the stationary post to maintain a constant one pound per inch wide sample tension. Since there were three idling rollers in the test device, each complete rotation cycle of the disk would produce three fatigue bending flexes strain in the charge transport layer since the segment of the imaging member sample was making a mechanical contact with only one single roller at a time during each testing cycle. The rotation of the spinning disk was adjusted to provide the equivalent of 11.3 inches (28.7 cm.) per second tangential speed. The sample is observed under an optical microscope for the onset of craching. The onset of charge transport layer cracking was notable sooner for the imaging member of Example 1.

### EXAMPLE 4

### Xerographic Testing of Electrophotographic Imaging Members of Examples 1 and 2

The flexible photoreceptor sheets prepared as described in Examples were tested for their xerographic sensitivity and cyclic stability in a scanner. In the scanner, each photoreceptor sheet to be evaluated was mounted on a cylindrical aluminum drum substrate which was rotated on a shaft.

The devices were charged by a direct current pin corotron mounted along the periphery of the drum. The surface potential was measured as a function of time by capacitively coupled voltage probes placed at different locations around the shaft. The probes were calibrated by applying known potentials to the drum substrate. Each photoreceptor sheet on the drum was exposed to a light source located at a position near the drum downstream from the corotron. As the drum was rotated, the initial (pre-exposure) charging potential was measured by a voltage probe. Further rotation lead to an exposure station, where the photoreceptor device was exposed to monochromatic radiation of a known intensity. The devices were erased by a light source located at a position upstream of charging. The measurements illustrated in Table 1 included the charging of each photoconductor device in a constant current or voltage mode. The devices were charged to a negative polarity corona. The surface potential after exposure was measured by a second voltage probe. The devices were finally exposed to an erase lamp of appropriate intensity and any residual potential was measured by a third voltage probe. The process was repeated with the magnitude of the exposure automatically changed during the next cycle. The photodischarge characteristics were obtained by plotting the potentials at a voltage probe as a function of light exposure. The charge acceptance and dark decay were also measured in the scanner. The charge acceptance is measured by operating the corotron in a constant current mode. VDDP, the dark development potential, is the potential remaining on the device at a specified time after the charging step. No difference observed between the electrophotographic imaging members of Examples 1 and 2.

TABLE 1

| | Surface potential | 3.8 erg/cm2 | | |
|---|---|---|---|---|
| | constant voltage | exposure | | |
| | mode | Background | Dark Decay | Residual |
| Example | Volts | volts | Volts/second | voltage |
| Example 1 | 800 | 92 | −84 | 38 |
| Example 2 | 800 | 92 | −86 | 39 |

The concentration of hole transport molecule(s)/compounds(s) that maximize cycling life of the polycarbonate blend may vary in accord with the percent mixture of the polycarbonates, and the particular hole transport molecule used. For example, in a 50:50 mix of the 5900/5705 Makrolon polycarbonates, a 35% cm-TBD may show better cycling life, as adjudged by number of Kcycles with 3 flexes per cycle, than a layer comprising 50% m-TBD. Also the 50:50 mix of 5900/5705 Makrolon polycarbonates may comprise one or more layers or regions, such as a bottom charge transport layer and an upper or additional charge transport layer(s)

The polycarbonate blend charge transfer layer may be used in an electrophotographic imaging member, such as a belt electrophotographic imaging member.

It will be appreciated that variations of the above-disclosed embodiments and other features and functions, or alternatives thereof, may be desirably combined into many other different devices or applications. Also that various presently unforseen or unanticpated alternatives, modifications, variations or improvements therein may be subsequently made by those skill in the art which are also intended to be encompassed by the following claims.

What is claimed is:

1. An electrophotographic imaging member comprising a charge transport layer comprising at least one polycarbonate polymer binder having a weight average molecular weight based on polystyrene units of from about 150,000 to about 190,000 and at least one polycarbonate binder having a weight average molecular weight based on polystyrene units of from about 230,000 to about 300,000 and a hole transport material.

2. The electrophotographic imaging member claimed in claim 1, wherein said polycarbonate polymers contain structural repeating units represented by the formula 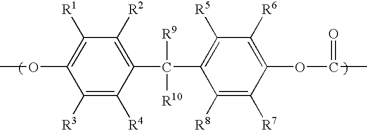
wherein R¹, R², R³, R⁴, R⁵, R⁶, R⁷ and R⁸ are respectively and independently a hydrogen atom, an alkyl group, a halogen atom, consider using aryl an unsubstituted or substituted aromatic group; and R⁹ and R¹⁰ are respectively and independently a hydrogen atom, an alkyl group, or an unsubstitued or substituted aromatic group or form a ring or a carbonyl group together with the linking carbon atom.

3. The electrophotographic imaging member of claim 1 wherein the polycarbonates is of the bisphenol Z type.

4. The electrophotographic imaging member of claim 1 wherein the polycarbonate is a of the bisphenol A type.

5. The electrophotographic imaging member of claim 1 wherein the polycarbonate is selected from at least one of a bisphenol Z type polycarbonate and a bisphenol A polycarbonate, or mixtures thereof.

6. The electrophotographic imaging member of claim 1 further comprising a charge generating layer.

7. The electrophotographic imaging member of claim 6 further comprising a charge blocking layer.

8. The electrophotographic imaging member of claim 1 wherein the hole transport material is 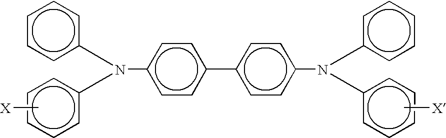
wherein X, X′ are independently selected from the group consisting of an alkyl, hydroxy and halogen.

9. The electrophotographic imaging member of claim 1 wherein the charge generating layer is an inorganic or organic photoconductive material.

10. The electrophotographic image member of claim 1 wherein the charge transport layer has a thickness of between about 10 micrometers to about 50 micrometers.

11. The electrophotographic imaging member of claim 1 wherein the thickness of the charge transport layer to the charge generating layer is between about 2:1 to about 200:1.

12. An electrophotographic imaging member comprising an electroconductive support and a photosensitive layer, said photosensitive layer comprising a photoconductive material and a charge transport layer comprising a polycarbonate resin having a weight average molecular weight based on polystyrene units of from about 150,000 to about 190,000 and a polycarbonate resin having a weight average molecular weight based on polystyrene units of from about to narrow 230,000 to about 300,000.

13. A process comprising dissolving a first polycarbonate with an about 230,000 to about 300,000 weight average molecular weight based on polystyrene units in a solution; adding a second polycarbonate with an about 150,000 to about 190,000 weight average molecular weight based on polystyrene units into said solution; adding hole transport components to said first and second polycarbonate.

14. The process of claim 13 wherein the first polycarbonate is dissolved in at least one of methylene chloride, tetrahydrofuran or a brominated solvent.

15. The process of claim 13 wherein the hole transport component comprises 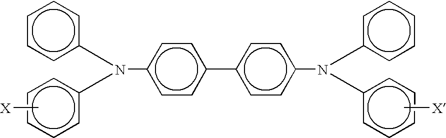
wherein X, X′ are independently selected from the group consisting of an alkyl, hydroxy and halogen.

16. The process of claim 13 wherein at least one polycarbonate is of the bisphenol A type or bisphenol Z type.

17. The process of claim 12 wherein the polycarbonates are dissolved together in an organic solvent.

18. The process of claim 17 wherein the organic solvent in which the polycarbonates are dissolved is methylene chloride.

19. An electrophotographic imaging member comprising a support substrate, at least one imaging layer on one side of said support substrate, a charge blocking layer, an optional adhesive layer, and a charge transporting layer, wherein said charge transporting layer comprises binder resin comprising a polycarbonate resin having a weight average molecular weight based on polystyrene units of from about 150,000 to about 190,000 and a polycarbonate resin having a weight average molecular weight based on polystyrene units of from about 230,000 to about 300,000.

20. A xerographic system comprising the electrophotographic photoreceptor of accordance with claim 1.

21. A xerographic system comprising the electrophotographic photoreceptor in accordance with claim 1, toner, and a charge corona.
